(19) United States
(12) Patent Application Publication
(10) Pub. No.: US 2021/0174697 A1
(43) Pub. Date: Jun. 10, 2021

(54) AWARENESS ENHANCEMENT MECHANISM

(71) Applicant: Intel Corporation, Santa Clara, CA (US)

(72) Inventors: Tobias Kohlenberg, Portland, OR (US); Michael Moran, Naas (IE); Charles Baron, Chandler, AZ (US); Stephen Chadwick, Chandler, AZ (US)

(21) Appl. No.: 17/072,929

(22) Filed: Oct. 16, 2020

Related U.S. Application Data
(63) Continuation of application No. 14/561,556, filed on Dec. 5, 2014, now abandoned.

(51) Int. Cl. G09B 19/00; G09B 5/00; G09B 5/06

(52) U.S. Cl. CPC G09B 19/00; G09B 5/06; G09B 5/00

(57) ABSTRACT

A mechanism is described to facilitate dynamic selection of avatars according to one embodiment. A method of embodiments, as described herein, includes acquiring sensory data, processing the sensory data to detect and identify one or more surrounding objects of which a user should be made aware, determining a relevance of the one or more objects and to prioritize relevant objects as events and providing feedback based on the events.

### FIELD

Embodiments described herein generally relate to wearable computing. More particularly, embodiments relate to dynamic prioritization of surrounding events based on contextual information.

### BACKGROUND

Various wearable device applications are currently being implemented to assist user-awareness of activity outside of the user's field of vision or range of awareness. For example, hearing aid applications focus on using specific algorithms to amplify sound. However, such applications focus on the simple translation of sensory data from one sense to another, or amplification of the sensory data to a level where the user can perceive it. Moreover existing solutions do not take into account a change surroundings during user activity. Specifically, current assisting devices do not account for a user's full field of awareness in order to provide information to the user.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates an awareness enhancement mechanism at a computing device according to one embodiment.

FIG. 2 illustrates one embodiment of an awareness enhancement mechanism.

FIG. 3 illustrates one embodiment of contextual awareness ranges.

FIG. 4 illustrates one embodiment of an awareness enhancement device.

FIG. 5 illustrates one embodiment of a contextual awareness application.

FIG. 6 illustrates another embodiment of an awareness enhancement device.

FIGS. 7A & 7B illustrate embodiments of contextual awareness applications.

FIGS. 8 is a flow diagram illustrating one embodiment of a process performed by an awareness enhancement mechanism.

FIG. 9 illustrates computer system suitable for implementing embodiments of the present disclosure according to one embodiment.

### DETAILED DESCRIPTION

Embodiments may be embodied in systems, apparatuses, and methods for enhanced awareness, as described below. In the description, numerous specific details, such as component and system configurations, may be set forth in order to provide a more thorough understanding of the present invention. In other instances, well-known structures, circuits, and the like have not been shown in detail, to avoid unnecessarily obscuring the present invention.

Embodiments provide for an awareness enhancement mechanism that uses logical heuristic models, user sensory capacity and physics to prioritize events that may require user attention. In such embodiments, a combination of contextual information and user training are analyzed to provide awareness enhancement. Accordingly, the awareness enhancement mechanism determines events that are likely to not be noticed by a user while the user is performing different activities based on limitations of the user's senses (e.g., user range of peripheral vision during different tasks). In a further embodiment, prioritization of events is implemented by evaluating characteristics of an event to determine the urgency of notification and best method of notification. In various embodiments, the awareness enhancement mechanism is integrated into a wearable device that includes assistive capabilities.

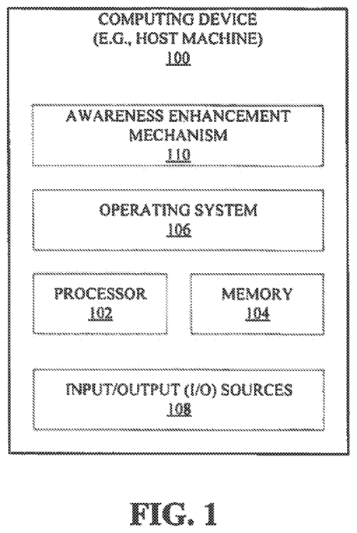

FIG. 1 illustrates an awareness enhancement mechanism 110 at a computing device 100 according to one embodiment. In one embodiment, computing device 100 serves as a host machine for hosting awareness enhancement mechanism (“awareness mechanism”) 110 that includes a combination of any number and type of components for facilitating dynamic prioritization and notification of events at computing devices, such as computing device 100. In one embodiment, computing device 100 includes a wearable device. Thus, implementation of awareness mechanism 110 results in computing device 100 being an assistive device to determine relevancy and priority in relation to the identification, tracking, and notification of stationary and moving objects that surround a wearer of computing device 100.

In other embodiments, awareness enhancement operations may be performed at a computing device 100 including large computing systems, such as server computers, desktop computers, etc., and may further include set-top boxes (e.g., Internet-based cable television set-top boxes, etc.), global positioning system (GPS)-based devices, etc. Computing device 100 may include mobile computing devices, such as cellular phones including smartphones (e.g., iPhone® by Apple®, BlackBerry® by Research in Motion®, etc.), personal digital assistants (PDAs), tablet computers (e.g., iPad® by Apple®, Galaxy 3® by Samsung®, etc.), laptop computers (e.g., notebook, netbook, Ultrabook™, etc.), e-readers (e.g., Kindle® by Amazon®, Nook® by Barnes and Nobles®, etc.), etc.

Computing device 100 may include an operating system (OS) 106 serving as an interface between hardware and/or physical resources of the computer device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc.

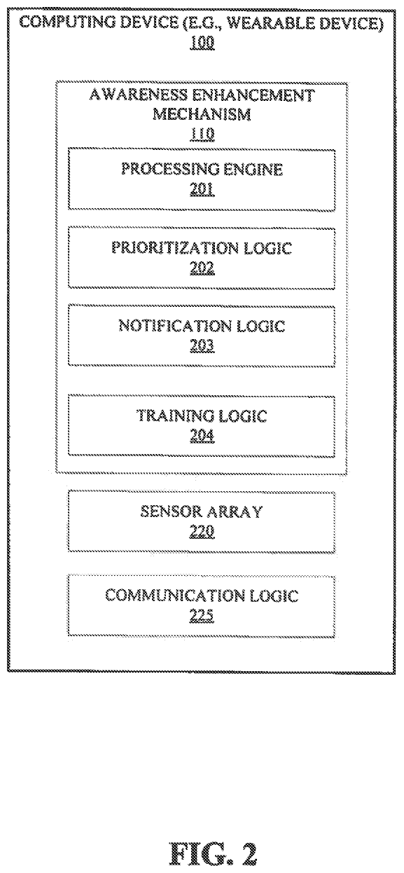

FIG. 2 illustrates an awareness enhancement mechanism 110 employed at computing device 100. In one embodiment, awareness enhancement mechanism 110 may include any number and type of components, such as: processing engine 201, prioritization logic 202, notification logic 203 and training logic 204. In one embodiment, processing engine 201 receives sensory data from a sensor array 220 and performs an analysis and response to events based on the information. In such an embodiment, processing engine 201 processes the sensory data to detect and identify one or more surrounding objects of which wearer of device 100 (or user) should be made aware. Further, processing engine 201 tracks the surrounding objects to determine objects that are stationary and objects that may be moving.

Prioritization logic 202 determines the relevance of the surrounding objects and prioritizes relevant objects as events based on characteristics of particular events. In one embodiment, the events include a velocity of an oncoming object, a type of object (e.g., alive, intelligent, inert, mobile, etc.), a size of the object. In some embodiments, job-specific rule sets are generated and used to prioritize attention to events that are specifically important for a user's scope of employment (e.g., construction worker, fisherman, law enforcement).

Notification logic 203 provides feedback to user based on processed events received from processing logic 201 and prioritization 202. In one embodiment, notification logic 203 provides immediate feedback in the form of selective audio amplification in order to augment and extend the users natural auditory awareness. In a further embodiment, non-speech audio (e.g., sonification) may be used to convey information or perceptualized data to the user. In still a further embodiment, objects may be represented with various virtual sounds selected by a user during the training mode.

In one embodiment, notification logic 203 may implement warning sounds to alert a user prior to the user walking into an object upon processing logic 201 determining that the user does not see the object. In an alternative embodiment, processing logic 201 may wirelessly communicate with other computing device via communication logic 225 to provide warning feedback to prevent collisions. For example, the user may lightly feel he/she is about to walk into an object and be safely guided around the object (e.g., virtual walking stick).

Training logic 204 implements a training mode that enables customization of awareness enhancement mechanism 110 for a user. According to one embodiment, training logic 204 determines a user's range of senses and how the ranges change during various activities. In such an embodiment, activities may include a user walking down a street with head up, reading with reading material a predetermined distance (e.g., 20 cm-30 cm) from the face, watching a particular action at a predetermined distance (e.g., more than 3 m) and participating in a conversation with a differing number of individuals.

In a further embodiment, training logic 204 performs basic reflex tests to determine an amount forewarning necessary for the user to respond to different kinds of events. In a further embodiment, training logic 204 includes heuristic models to determine how user awareness is impacted by a broad number of activities. In such an embodiment, exemplary activities may include reading (e.g., material at close, middle and long ranges), having an object in front of the user to calculate a level of occultation, walking and paying attention to surroundings to calculate a general state of awareness world, talking on a telephone, talking to a person to account for a narrow focus on the person and the part of the field of vision blocked by the person, napping. According to one embodiment, the training is applied to the heuristic models to create a customized awareness map for the user.

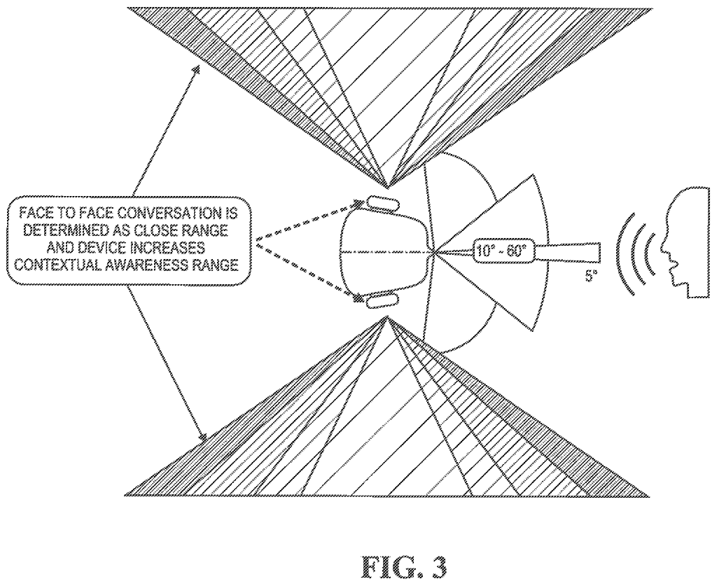

FIG. 3 illustrates one embodiment of contextual awareness ranges determined at training logic 202 during a training mode in which a device 100 learns a user field of vision. In this embodiment, face to face conversation between a user and another person is determined at a close range. During the conversation, training logic 204 increases the contextual awareness range based on user awareness limitations.

In embodiments, awareness enhancement mechanism 110 receives audio and image data from sensor array 220, where the image data may be in the form of a sequence of images or frames (e.g., video frames). Sensor array 220 may include an image capturing device, such as a camera. Such a device may include various components, such as (but are not limited to) an optics assembly, an image sensor, an image/video encoder, etc., that may be implemented in any combination of hardware and/or software. The optics assembly may include one or more optical devices (e.g., lenses, mirrors, etc.) to project an image within a field of view onto multiple sensor elements within the image sensor. In addition, the optics assembly may include one or more mechanisms to control the arrangement of these optical device(s). For example, such mechanisms may control focusing operations, aperture settings, exposure settings, zooming operations, shutter speed, effective focal length, etc. Embodiments, however, are not limited to these examples.

Image sources may further include one or more image sensors including an array of sensor elements where these elements may be complementary metal oxide semiconductor (CMOS) sensors, charge coupled devices (CCDs), or other suitable sensor element types. These elements may generate analog intensity signals (e.g., voltages), which correspond to light incident upon the sensor. In addition, the image sensor may also include analog-to-digital converter(s) ADC(s) that convert the analog intensity signals into digitally encoded intensity values. Embodiments, however, are not limited to these examples. For example, an image sensor converts light received through optics assembly into pixel values, where each of these pixel values represents a particular light intensity at the corresponding sensor element. Although these pixel values have been described as digital, they may alternatively be analog. As described above, the image sensing device may include an image/video encoder to encode and/or compress pixel values. Various techniques, standards, and/or formats (e.g., Moving Picture Experts Group (MPEG), Joint Photographic Expert Group (JPEG), etc.) may be employed for this encoding and/or compression.

In a further embodiment, sensor array 220 may include other types of sensing components, such as context-aware sensors (e.g., myoelectric sensors, temperature sensors, facial expression and feature measurement sensors working with one or more cameras, environment sensors (such as to sense background colors, lights, etc.), biometric sensors (such as to detect fingerprints, facial points or features, etc.), and the like.

During operation, processing engine 201 may generate ambient noises, or supplement existing noises, based on computer image recognition and other contextual data. For example, a user may be surrounded by many people and only hear chatter. A simulated range of background music/atmospheric tones may supplement the existing background noise to evoke a wide range of moods from upbeat happy to ominous fear based on a three-dimensional mapping, object recognition, ambient lighting, contextual awareness, location, time of day, news/events, etc. This feedback may be formed into subtle cues to alert the user to either enjoy the party or escape from an impending riot.

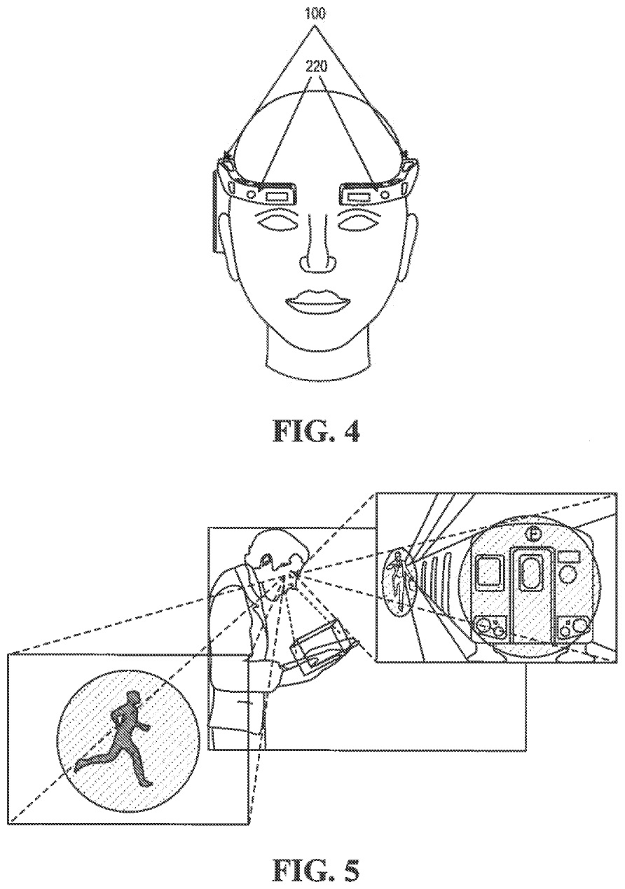

FIG. 4 illustrates one embodiment of a device 100 implementing an awareness enhancement mechanism 110. A shown in FIG. 4, device 100 is a wearable device worn on a user's head. Device 100 includes sensors 220 that enable the wearer to have contextual awareness of approaching objects. FIG. 5 illustrates one embodiment of a contextual awareness application performed by the device 100 shown in FIG. 4. As shown in FIG. 5, the central field vision of a user is focused on reading a book, which causes temporary tunnel vision and a loss of peripheral vision. However, awareness enhancement mechanism 110 provides contextual awareness of objects approaching on each side of the user while reading the book. For example, awareness enhancement mechanism 110 provides the user with awareness of objects (e.g., a person and a train) peripherally approaching to the left, as well as awareness of a person peripherally approaching to the right.

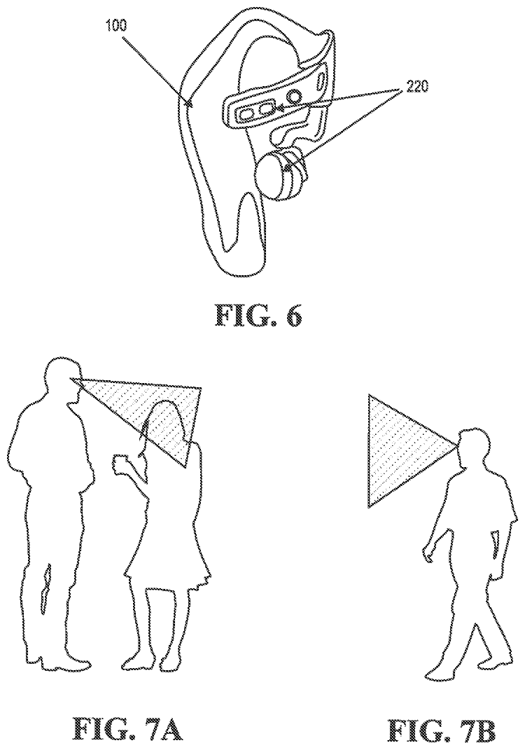

FIG. 6 illustrates another embodiment of a device 100 implementing an awareness enhancement mechanism 110. In this embodiment, device 100 is a wearable device worn on a user's ear. In this embodiment, device 100 uses contextual activity information to determine a user's level of awareness. FIGS. 7A & 7B illustrate embodiments of a contextual awareness application performed by the device 100 shown in FIG. 6. FIG. 7A shows that a user's external focus is reduced due to being engaged in a conversation. Accordingly, awareness enhancement mechanism 110 increases contextual information awareness. FIG. 7B shows that a user's external focus is at a maximum. Thus, awareness enhancement mechanism 110 may decrease contextual information awareness.

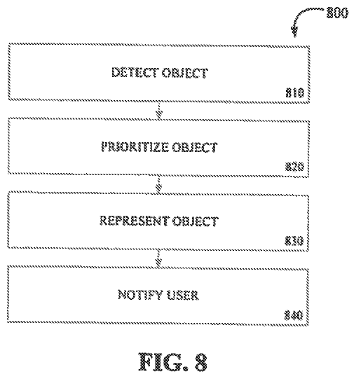

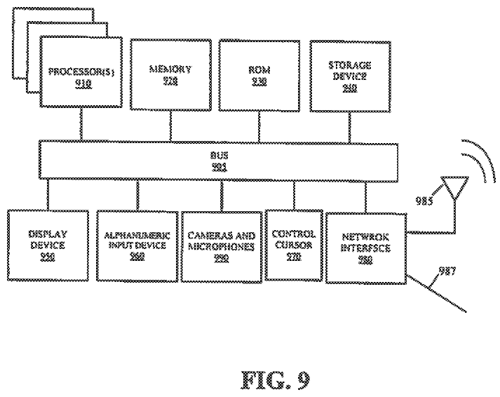

FIGS. 8 is a flow diagram illustrating one embodiment of a process 800 performed by an awareness enhancement mechanism. Process 800 may be performed by processing logic that may comprise hardware (e.g., circuitry, dedicated logic, programmable logic, etc.), software (such as instructions run on a processing device), or a combination thereof. In one embodiment, method 800 may be performed by awareness enhancement mechanism 110. The processes of method 800 are illustrated in linear sequences for brevity and clarity in presentation; however, it is contemplated that any number of them can be performed in parallel, asynchronously, or in different orders. For brevity, clarity, and ease of understanding, many of the details discussed with reference to FIGS. 1 and 2 are not discussed or repeated here.

At processing block 810, one or more approaching objects are detected and identified by awareness enhancement mechanism 110. At processing block 820, prioritization occurs to determine relevance of the one or more objects and to prioritize relevant objects as events. At processing block 830, the object is represented with a virtual sound. At processing block 840, the user is notified of the approaching object using the virtual sound.

In an exemplary use case implementing process 800, a user could be napping with eyes closed when awareness enhancement mechanism 110 performs process 800 to notify the user of a person walking towards the user from a direction of approach. In one embodiment, the notification is performed with the person being represented with simulated surround sound footsteps since the person's footsteps may be too quiet or masked by ambient noise in the environment. In another example, the user may be sunbathing on the beach, with ocean waves drowning out the sounds of people playing nearby. In such an instance, enhancement mechanism 110 may be trained to only notify the user of a stranger approaching the user in a straight line, while ignoring users that are walking past.

In yet another example, awareness enhancement mechanism 110 may identify an errant frisbee gliding quickly towards a user's head from behind and make the user virtually aware of the frisbee sooner than the real-world environment, thus providing more time to respond and properly duck out of the way. In still another example, quiet noise of an electric vehicle failing to yield at a crosswalk may be artificially boosted by awareness enhancement mechanism 110 with simulated surround sound to increase awareness of its trajectory to the user, who may be texting while walking and about to collide with the vehicle.

It is contemplated that any number and type of components may be added to and/or removed from awareness enhancement mechanism 110 to facilitate various embodiments including adding, removing, and/or enhancing certain features. For brevity, clarity, and ease of understanding of awareness enhancement mechanism 110, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

Computing system 900 includes bus 905 (or, for example, a link, an interconnect, or another type of communication device or interface to communicate information) and processor 910 coupled to bus 905 that may process information. While computing system 900 is illustrated with a single processor, electronic system 900 and may include multiple processors and/or co-processors, such as one or more of central processors, graphics processors, and physics processors, etc. Computing system 900 may further include random access memory (RAM) or other dynamic storage device 920 (referred to as main memory), coupled to bus 805 and may store information and instructions that may be executed by processor 910. Main memory 920 may also be used to store temporary variables or other intermediate information during execution of instructions by processor 910.

Computing system 900 may also include read only memory (ROM) and/or other storage device 930 coupled to bus 905 that may store static information and instructions for processor 910. Date storage device 940 may be coupled to bus 905 to store information and instructions. Date storage device 940, such as magnetic disk or optical disc and corresponding drive may be coupled to computing system 900.

Computing system 900 may also be coupled via bus 905 to display device 950, such as a cathode ray tube (CRT), liquid crystal display (LCD) or Organic Light Emitting Diode (OLED) array, to display information to a user. User input device 960, including alphanumeric and other keys, may be coupled to bus 905 to communicate information and command selections to processor 910. Another type of user input device 960 is cursor control 970, such as a mouse, a trackball, a touchscreen, a touchpad, or cursor direction keys to communicate direction information and command selections to processor 910 and to control cursor movement on display 950. Camera and microphone arrays 990 of computer system 900 may be coupled to bus 905 to observe gestures, record audio and video and to receive and transmit visual and audio commands.

Computing system 900 may further include network interface(s) 980 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 980 may include, for example, a wireless network interface having antenna 985, which may represent one or more antenna(e). Network interface(s) 980 may also include, for example, a wired network interface to communicate with remote devices via network cable 987, which may be, for example, an Ethernet cable, a coaxial cable, a fiber optic cable, a serial cable, or a parallel cable.

Network interface(s) 980 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 980 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 980 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 900 may vary from implementation to implementation depending upon numerous factors, such as price constraints, performance requirements, technological improvements, or other circumstances. Examples of the electronic device or computer system 900 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes an apparatus to facilitate awareness enhancement, comprising a sensor array to acquire sensory data, processing engine to process the sensory data to detect and identify one or more surrounding objects of which a user should be made aware, prioritization logic to determine relevance of the one or more objects and to prioritize relevant objects as events and notification logic to provide feedback based on the events.

Example 2 includes the subject matter of Example 1, wherein the processing engine tracks the surrounding objects to determine objects that are stationary and objects that are moving.

Example 3 includes the subject matter of Example 1, wherein the prioritization logic generates job-specific rule sets to prioritize attention to events related to a scope of employment.

Example 4 includes the subject matter of Example 1, wherein the events include at least one of a velocity of an oncoming object, a type of object, a size of the object.

Example 5 includes the subject matter of Example 1, wherein the notification logic provides feedback in the form of selective audio amplification in order to augment and extend natural auditory awareness.

Example 6 includes the subject matter of Example 1, wherein the notification logic provides feedback in the form of non-speech audio to convey perceptual data.

Example 7 includes the subject matter of Example 1, further comprising training logic to implement a training mode to customize awareness enhancement.

Example 8 includes the subject matter of Example 7, wherein the training logic determines a range of senses and how the range changes during activities.

Example 9 includes the subject matter of Example 8, wherein the training logic performs reflex tests to determine an amount of forewarning to respond to events.

Example 10 includes the subject matter of Example 7, wherein the training logic includes heuristic models to determine how awareness is impacted by activities.

Example 11 includes the subject matter of Example 10, wherein the training logic applies the heuristic models to create a customized awareness map.

Some embodiments pertain to Example 12 that includes a method to facilitate awareness enhancement comprising acquiring sensory data, processing the sensory data to detect and identify one or more surrounding objects of which a user should be made aware, determining a relevance of the one or more objects and to prioritize relevant objects as events and providing feedback based on the events.

Example 13 includes the subject matter of Example 12, further comprising tracking the surrounding objects to determine objects that are stationary and objects that are moving.

Example 14 includes the subject matter of Example 12, wherein the events include at least one of a velocity of an oncoming object, a type of object, a size of the object.

Example 15 includes the subject matter of Example 12, wherein the feedback is provided in the form of selective audio amplification in order to augment and extend natural auditory awareness.

Example 16 includes the subject matter of Example 12, wherein the feedback is provided in the form of non-speech audio to convey perceptual data.

Example 17 includes the subject matter of Example 12, further comprising performing training to customize awareness enhancement.

Example 18 includes the subject matter of Example 17, wherein the training comprises determining a range of senses and how the range changes during activities.

Example 19 includes the subject matter of Example 17, wherein the training comprises performing reflex tests to determine an amount of forewarning to respond to events.

Example 20 includes the subject matter of Example 17, wherein the training comprises performing applying heuristic models to create a customized awareness map.

Some embodiments pertain to Example 21 that includes at least one machine-readable medium comprising a plurality of instructions that in response to being executed on a computing device, causes the computing device to carry out operations comprising acquiring sensory data, processing the sensory data to detect and identify one or more surrounding objects of which a user should be made aware, determining a relevance of the one or more objects and to prioritize relevant objects as events and providing feedback based on the events.

Example 22 includes the subject matter of Example 21, comprising a plurality of instructions that in response to being executed on a computing device, causes the computing device to further carry out operations comprising tracking the surrounding objects to determine objects that are stationary and objects that are moving.

Example 23 includes the subject matter of Example 21, comprising a plurality of instructions that in response to being executed on a computing device, causes the computing device to further carry out operations comprising performing training to customize awareness enhancement.

Example 24 includes the subject matter of Example 23, wherein the training comprises determining a range of senses and how the range changes during activities.

Example 25 includes the subject matter of Example 24, wherein the training comprises performing reflex tests to determine an amount of forewarning to respond to events.

Some embodiments pertain to Example 26 that includes at least one machine-readable medium comprising a plurality of instructions that in response to being executed on a computing device, causes the computing device to carry out the operations of claims 12-20.

Some embodiments pertain to Example 27 that includes a system to facilitate awareness enhancement comprising means for acquiring sensory data, means for processing the sensory data to detect and identify one or more surrounding objects of which a user should be made aware, means for determining a relevance of the one or more objects and to prioritize relevant objects as events and means for providing feedback based on the events.

Example 28 includes the subject matter of Example 27, further comprising means for tracking the surrounding objects to determine objects that are stationary and objects that are moving.

Example 29 includes the subject matter of Example 27, wherein the events include at least one of a velocity of an oncoming object, a type of object, a size of the object.

Example 30 includes the subject matter of Example 27, wherein the feedback is provided in the form of selective audio amplification in order to augment and extend natural auditory awareness.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1-25. (canceled)

26. An apparatus, comprising:
a sensor array to collect sensory data from a user environment; and
a processor to:
determine a range of peripheral vision of a user;
identify an object in the user environment based on the sensory data received from the sensor array;
determine a priority of the object based on an occupation of the user and the range of peripheral vision of the user; and
generate a notification to the user based on the priority of the object.

27. The apparatus of claim 26, wherein the priority of the object is further based on a characteristic of the object, the characteristic of the object including at least one of a type of the object, a velocity of the object, a size of the object, or a direction of movement of the object.

28. The apparatus of claim 27, wherein the processor is to determine a type of notification based on the characteristic of the object.

29. The apparatus of claim 28, wherein the type of notification includes a non-speech auditory signal.

30. The apparatus of claim 26, wherein the sensor array includes at least one of a visual sensor or an audio sensor.

31. The apparatus of claim 30, wherein the sensor array further includes at least one of a myoelectric sensor, a temperature sensor, or a biometric sensor.

32. The apparatus of claim 26, wherein the processor is to perform selective audio amplification to augment an auditory signal in the user environment based on the priority of the object.

33. The apparatus of claim 26, wherein the processor is to track the object based on the sensory data received from the sensor array to determine whether the object is stationary or mobile.

34. The apparatus of claim 26, wherein the processor is to generate a notification based on a determination by the processor that the object is outside the range of peripheral vision of the user.

35. The apparatus of claim 26, wherein the processor is to:
determine the range of peripheral vision of the user while the user is performing an activity; and
store the range of peripheral vision associated with the activity in memory.

36. A non-transitory computer readable medium comprising computer readable instructions that, when executed, cause at least one processor to at least:
collect, from a sensor array, sensory data from a user environment;
determine a range of peripheral vision of a user;
identify an object in the user environment based on the sensory data;
determine a priority of the object based on an occupation of the user and the range of peripheral vision of the user; and
generate a notification to the user based on the priority of the object.

37. The non-transitory computer readable medium of claim 36, wherein the priority of the object is further based on a characteristic of the object, the characteristic of the object including at least one of a type of the object, a velocity of the object, a size of the object, or a direction of movement of the object.

38. The non-transitory computer readable medium of claim 37, wherein the processor determines a type of notification based on the characteristic of the object.

39. The non-transitory computer readable medium of claim 38, wherein the type of notification includes a non-speech auditory signal.

40. The non-transitory computer readable medium of claim 36, wherein the sensor array includes at least one of a visual sensor or an audio sensor.

41. The non-transitory computer readable medium of claim 40, wherein the sensor array further includes at least one of a myoelectric sensor, a temperature sensor, or a biometric sensor.

42. The non-transitory computer readable medium of claim 36, wherein the computer readable instructions are further to cause the at least one processor to perform selective audio amplification to augment an auditory signal in the user environment based on the priority of the object.

43. The non-transitory computer readable medium of claim 36, wherein the computer readable instructions are further to cause the at least one processor to track the object based on the sensory data to determine whether the object is stationary or mobile.

44. The non-transitory computer readable medium of claim 36, wherein the computer readable instructions are further to cause the at least one processor to generate a notification based on a determination by the processor that the object is outside the range of peripheral vision of the user.

45. The non-transitory computer readable medium of claim 36, wherein the computer readable instructions are further to cause the at least one processor to:
determine the range of peripheral vision of the user while the user is performing an activity; and
store the range of peripheral vision associated with the activity in memory.

46. A method, comprising:
collecting, by a sensor array, sensory data from a user environment;
determining, by executing instructions with at least one processor, a range of peripheral vision of a user;
identifying, by executing instructions with the at least one processor, an object in the user environment based on the sensory data;
determining, by executing instructions with the at least one processor, a priority of the object based on an occupation of the user and the range of peripheral vision of the user; and
generating, by executing instructions with the at least one processor, a notification to the user based on the priority of the object.

47. The method of claim 46, wherein the priority of the object is further based on a characteristic of the object, the characteristic of the object including at least one of a type of the object, a velocity of the object, a size of the object, or a direction of movement of the object.

48. The method of claim 46, including performing selective audio amplification to augment an auditory signal in the user environment based on the priority of the object.

49. The method of claim 46, including generating a notification based on a determination by the processor that the object is outside the range of peripheral vision of the user.

50. The method of claim 46, including determining the range of peripheral vision of the user while the user is performing an activity and stores the range of peripheral vision associated with the activity in memory.
